(19) United States
(12) Patent Application Publication
(10) Pub. No.: US 2020/0307168 A1
(43) Pub. Date: Oct. 1, 2020

(54) COMPOSITE FABRIC WITH HOLES AND LIGHT-SHIELDING FILM

(71) Applicant: Industrial Technology Research Institute, Hsinchu (TW)

(72) Inventors: CHUN-MIN LEE, Hsinchu County (TW); YUNG-PIN HUANG, New Taipei City (TW); KUO-HSING LEE, Hsinchu City (TW); PEI-YI YEH, Changhua County (TW)

(21) Appl. No.: 16/729,682

(22) Filed: Dec. 30, 2019

Related U.S. Application Data
(60) Provisional application No. 62/824,362, filed on Mar. 27, 2019.

(51) Int. Cl. B32B 17/10; B32B 3/26; B32B 5/02; B32B 7/12; B32B 27/12

(52) U.S. Cl. CPC B32B 17/1077; B32B 3/266; B32B 5/022; B32B 5/024; B32B 7/12; B32B 2367/00; B32B 27/12; B32B 2307/40; B32B 2313/04; B32B 2375/00; B32B 17/10779

(57) ABSTRACT

A composite fabric includes at least a surface sheet fabric, a light-shielding film and a bottom sheet fabric. The light-shielding film is sandwiched as a unique piece between the surface sheet fabric and the bottom sheet fabric. The light-shielding film contains light-shielding particles or powders. At least one of the surface sheet fabric, the bottom sheet fabric and the light-shielding film is furnished with a plurality of holes.

### CROSS REFERENCE TO RELATED APPLICATION

This application claims the benefits of U.S. provisional application Ser. No. 62/824,362, filed on Mar. 27, 2019, the disclosures of which are incorporated by references herein in its entirety.

### TECHNICAL FIELD

The present disclosure relates in general to a composite fabric with holes and a light-shielding film.

### BACKGROUND

In the art, a curtain fabric is generally made up by typical perspective light-shielding fabrics such as mesh fabrics through weaving dark yarns in a specific pattern such as cross or interlaced weaving. In order to furnish the curtain fabric with a light-shielding feature, using the dark yarns as the base is necessary. In addition, according to different weaving patterns, styles and distributions of the holes would be differed to each other.

### SUMMARY

An object of the present disclosure is to provide a composite fabric with holes that can be furnished with advantages in light-shielding and visibility.

In one embodiment of this disclosure, the composite fabric includes at least a surface sheet fabric, a light-shielding film and a bottom sheet fabric. The light-shielding film is sandwiched as a unique piece between the surface sheet fabric and the bottom sheet fabric. The light-shielding film contains light-shielding particles or powders. At least one of the surface sheet fabric, the bottom sheet fabric and the light-shielding film is furnished with a plurality of holes.

In one embodiment of this disclosure, the light-shielding film is a polymeric film or a nanofiber film.

In one embodiment of this disclosure, the light-shielding film is made of a polyurethane or a thermoplastic elastomer.

In one embodiment of this disclosure, the particles or powders are carbon black particles or CsW(Cesium tungstate) particles. The particles or powders share 20˜60 wt % of the light-shielding film, and the composite fabric has a total luminous transmittance less than 30%.

In one embodiment of this disclosure, the light-shielding film is one of a carbon black-modified light-shielding film contained carbon black particles or powders, a Cs-W-modified light-shielding film contained Cs-W particles or powders, a carbon nanotube-modified light-shielding film contained carbon nanotube particles or powders, a graphene-modified light-shielding film contained graphene particles or powders, a coke-modified light-shielding film contained coke particles or powders, and a ZrC-modified light-shielding film contained ZrC particles or powders.

In one embodiment of this disclosure, the surface sheet fabric and the bottom sheet fabric are woven or non-woven fabrics.

In one embodiment of this disclosure, an adhesive is applied to both sides of the light-shielding film, and then the both sides of the light-shielding film are laminated with the surface sheet fabric and the bottom sheet fabric, respectively.

In one embodiment of this disclosure, the light-shielding film is laminated between the surface sheet fabric and the bottom sheet fabric by hot pressing.

In one embodiment of this disclosure, at least one of the surface sheet fabric, the bottom sheet fabric and the light-shielding film is furnished with a plurality of holes by direct punching, laser melting, weaving or knitting.

In one embodiment of this disclosure, the plurality of holes has a total area larger than 0.25% of an area of the composite fabric.

In one embodiment of this disclosure, the composite fabric has a haze value less than 33%.

In one embodiment of this disclosure, the light-shielding film has a thickness between 1 μm and 80 μm.

In another aspect of this disclosure, a light-shielding nanofiber film contains light-shielding particles or powders for light shielding.

In one embodiment of this disclosure, the light-shielding nanofiber film was made of a polyurethane or a thermoplastic polyesterelastomer, in which the light-shield nanofiber film contains light-shielding particles or powders, and the light-shielding particles or powders share 20˜60 wt % of the light-shielding nanofiber film.

In one embodiment of this disclosure, the light-shielding nanofiber film has a total luminous transmittance less than 30%.

In one embodiment of this disclosure, the light-shielding nanofiber film is one of a carbon black-modified light-shielding film contained carbon black particles or powders, a Cs-W-modified light-shielding film contained Cs-W particles or powders, a carbon nanotube-modified light-shielding film contained carbon nanotube particles or powders, a graphene-modified light-shielding film contained graphene particles or powders, a coke-modified light-shielding film contained coke particles or powders and a ZrC-modified light-shielding film contained ZrC particles or powders.

In one embodiment of this disclosure, the light-shielding nanofiber film has a thickness between 1 μm and 80 μm.

As stated above, in the composite fabric of this disclosure, at least one of the surface sheet fabric, the bottom sheet fabric and the middle light-shielding film containing light-shielding particles or powders is furnished with a plurality of holes. Thereupon, light shielding, light transmitting and clear visibility can be obtained.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic perspective view of a first embodiment of the composite fabric with holes in accordance with this disclosure;

FIG. 2 is a schematic cross-sectional view of FIG. 1;

FIG. 3A is a schematic front view of FIG. 1; and

FIG. 3B is a schematic front view of a second embodiment of the composite fabric with holes in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

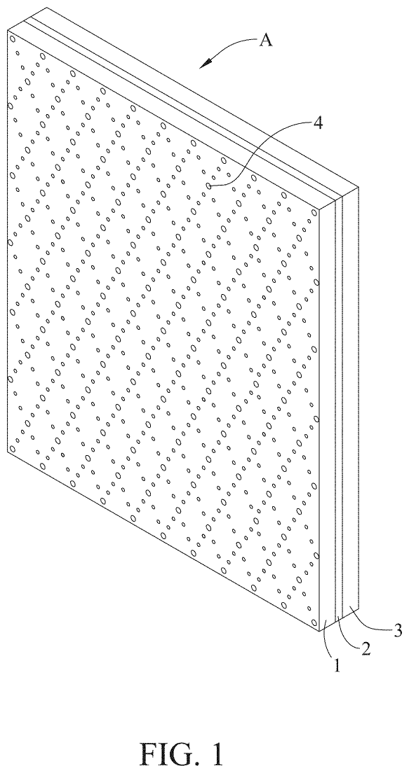

Referring to FIG. 1, a perspective view of a first embodiment of the composite fabric with holes in accordance with this disclosure is schematically shown. In this embodiment, it is shown that the composite fabric A is a three-layer structure. The composite fabric A includes at least a surface sheet fabric 1, a light-shielding film 2 and a bottom sheet fabric 3. According to this embodiment, the composite fabric with holes A can be produced by firstly forming holes to at least one of the surface sheet fabric 1, the light-shielding film 2 and the bottom sheet fabric 3, and then laminating these three layers (the surface sheet fabric 1, the light-shielding film 2 and the bottom sheet fabric 3) together as a unique piece. However, the method for fabricating the composite fabric A is not limited to the foregoing process. In another embodiment, the composite fabric with holes A can be produced by firstly laminating the surface sheet fabric 1 and the light-shielding film 2, then forming holes, and finally laminating the bottom sheet fabric 3. In a further embodiment, the composite fabric with holes A can be produced by firstly laminating the bottom sheet fabric 3 and the light-shielding film 2, then forming holes, and finally laminating the surface sheet fabric 1. In a furthermore embodiment, the composite fabric with holes A can be produced by firstly laminating the surface sheet fabric 1, the light-shielding film 2, the bottom sheet fabric 3, and another cloth or another light-shielding film are laminated together as a unique piece, and then forming the holes. In any of above embodiments, the holes are formed to the light-shielding film after the light-shielding film is adhered to at least one of the surface sheet fabric and the bottom sheet fabric, such that possible damages of yarns, broken or missed, can be avoided at the surface sheet fabric or the bottom sheet fabric. In another embodiment, the composite fabric with holes A is formed by laminating the surface sheet fabric 1, the light-shielding film 2 and the bottom sheet fabric 3 together, in which one of the surface sheet fabric 1 and the bottom sheet fabric 3 has woven holes already before the laminating process. According to this disclosure, the hole-forming process can be, but not limited to, a direct punch process, a thermal laser punch process, or any the like. Alternatively, holes on the surface sheet fabric or the bottom sheet fabric can be formed by a weaving or non-weaving process. In one embodiment, a total area of a plurality of holes 4 shares at least 0.25% area of the composite fabric with holes A, and patterns of the holes 4 can be various, not limited to the patterns shown in the figure.

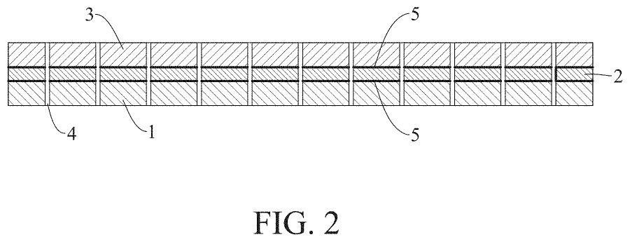

Referring now to FIG. 2, a cross-sectional view of the composite fabric with holes A of FIG. 1 is schematically shown. In this embodiment, the light-shielding film 2 is adhered with the surface sheet fabric 1 and the bottom sheet fabric 3 via an adhesive 5. Alternatively, the light-shielding film 2 can be adhered with the surface sheet fabric 1 and the bottom sheet fabric 3 by a thermal pressing process (not shown in the figure).

According to this disclosure, the light-shielding film 2 is a polymeric film or a nanofiber film containing light-shielding particles or powders. In one embodiment, the light-shielding film 2 can be made of a polyurethane or a thermoplastic elastomer. In one embodiment, the light-shielding particles or powders can be made of a material having a reflectivity less than 5% (with a powder-tablet penetration rate <0.5%) with respect to both the visible light with a wavelength ranging from 380-780 nm and the near infrared light with a wavelength ranging 780-2100 nm, tested and confirmed by a reflective light testing on a VIS-NIR integrating-sphere spectrometer. In one embodiment of this disclosure, the light-shielding film 2 can be a carbon black-modified light-shielding film contained carbon black particles or powders, a Cs-W-modified light-shielding film contained Cs-W particles or powders, a carbon nanotube-modified light-shielding film contained carbon nanotube particles or powders, a graphene-modified light-shielding film contained graphene particles or powders, a coke-modified light-shielding film contained coke particles or powders or a ZrC-modified light-shielding film contained ZrC particles or powders.

The light-shielding particles or powders in the light-shielding film 2 shares 20 wt %˜60 wt % of the entire light-shielding film 2, so that a specific light transmission effect can be furnished to the light-shielding film 2 without degrading too much in the light-shielding performance, in which wt % stands for the weight percentage concentration. In one embodiment, the light-shielding film 2 has a thickness ranging from 1˜80 μm.

In this disclosure, the surface sheet fabric 1 and the bottom sheet fabric 3 can be made of woven or non-woven fabrics. In one embodiment, the surface sheet fabric 1 and the bottom sheet fabric 3 are made of woven or knitted fabrics. In one embodiment, the surface sheet fabric 1 and the bottom sheet fabric 3 are light-color fabrics.

In order to define the clear visibility, a haze value equation as follows is applied in this disclosure.

$$\frac{{T}_{d}}{{T}_{t}} \times 100 \% = Haze value$$

in which Tₜ is the total luminous transmittance, and T_{d} is the diffuse luminous transmittance. In addition,

Tₜ=T_{d}Tₚ

in which Tₚ is the penetrate luminous transmittance. Generally, the diffuse luminous transmittance T_{d} and the penetrating luminous transmittance Tₚ are both obtained from corresponding testing on the VIS-NIR integrating-sphere spectrometer. Generally speaking, the larger the haze value is, the lower the clear visibility would be. According to this disclosure, a haze value less than 33% is acceptable.

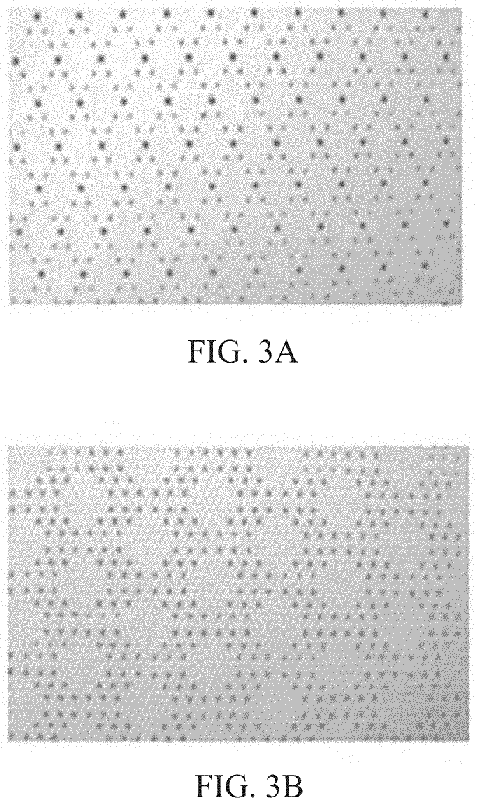

Referring to FIG. 3A and FIG. 3B, front views of the aforesaid first embodiment and a second embodiment of the composite fabric with holes in accordance with this disclosure are schematically shown, respectively. Referring also to Table 1 as follows, both the surface sheet fabric and the bottom sheet fabric in either of the first embodiment, the second embodiment and a 2A-th embodiment adopt the light-color woven fabric, while the light-shielding film thereof adopts a carbon black-modified polyurethane (PU) nanofiber film contained 50 wt % carbon black.

TABLE 1

| | Light-shielding | Tₚ | T_{d} | Haze value |
|---|---|---|---|---|
| Embodiment | film | (%) | (%) | (%) |
| First | Carbon black- | 4.5 | 0.8 | 15.1 |
| Second | modified | 6.0 | 1.0 | 14.3 |
| 2A-th | polyurethane (PU) | 0.25 | 0.1 | 28.5 |
| | nanofiber film | | | |
| | contained 50 wt % | | | |
| | carbon black | | | |

Referring to Table 1 and FIG. 3A, after the surface sheet fabric, the light-shielding film and the bottom sheet fabric of the first embodiment are laminated and then furnished with holes, the composite fabric with a specific pattern as shown in FIG. 3A can be formed. With this pattern, the penetrating luminous transmittance is 4.5%, and the corresponding measured diffuse luminous transmittance is 0.8%. By applying the foregoing equation, the haze value of this first embodiment is 15.1%, which is deemed to be clearly visible.

Referring to Table 1 and FIG. 3B, after the surface sheet fabric, the light-shielding film and the bottom sheet fabric of the first embodiment are laminated and then furnished with holes, the composite fabric with a specific pattern as shown in FIG. 3B can be formed. With this pattern for the second embodiment and the 2A-th embodiment, the penetrating luminous transmittance are 6.0% and 0.25%, and the corresponding measured diffuse luminous transmittance are 1.0% and 0.1%, respectively. By applying the foregoing equation, the haze values of the second and 2A-th embodiments are 14.3% and 28.5%, respectively, both of which are deemed to be clearly visible.

Referring now to Table 2, the surface sheet fabric and the bottom sheet fabric for each of four embodiments, a third embodiment to a sixth embodiment (not shown in the figure) adopt light-color woven fabrics, while the light-shielding film adopts the carbon black-modified PU film contained 20 wt % carbon black.

TABLE 2

| | Light-shielding | Tₚ | T_{d} | Haze value |
|---|---|---|---|---|
| Embodiment | film | (%) | (%) | (%) |
| Third | Carbon black- | 3.0 | 0.7 | 18.9 |
| Fourth | modified (PU) | 6.05 | 0.63 | 9.43 |
| Fifth | plastic film | 7.38 | 0.77 | 9.46 |
| Sixth | contained 20 wt % | 11.76 | 0.93 | 7.34 |
| | carbon black | | | |

Referring to Table 2, in each of the third embodiment to the sixth embodiment, after the surface sheet fabric, the light-shielding film and the bottom sheet fabric are laminated, a hole-making means is applied to form different penetrating luminous transmittance for the third embodiment to the sixth embodiment. In Table 2, the penetrating luminous transmittance for the third embodiment to the sixth embodiment are 3.0%, 6.05%, 7.38% and 11.76%, respectively, and the corresponding measured diffuse luminous transmittance are 0.7%, 0.63%, 0.77% and 0.93%, respectively. By applying the foregoing equation, the haze values for the third embodiment to the sixth embodiment are 18.9%, 9.43%, 9.46% and 7.34%, respectively. Namely, the composite fabric in each of the third embodiment to the sixth embodiment is deemed to be clearly visible.

Referring now to Table 3, the surface sheet fabric and the bottom sheet fabric for each of four embodiments, a seventh embodiment to a tenth embodiment (not shown in the figure) adopt light-color woven fabrics, while the light-shielding film adopts the carbon black-modified PU nanofiber film contained 50 wt % carbon black.

TABLE 3

| | Light-shielding | Tₚ | T_{d} | Haze value |
|---|---|---|---|---|
| Embodiment | film | (%) | (%) | (%) |
| Seventh | carbon black- | 2.85 | 0.67 | 19.0 |
| Eigth | modified PU | 5.75 | 1.07 | 15.63 |
| Ninth | nonfiber film | 7.29 | 1.07 | 12.77 |
| Tenth | contained 50 wt % | 12.16 | 1.62 | 11.76 |
| | carbon black | | | |

Referring to Table 3, in each of the seventh embodiment to the tenth embodiment, after the surface sheet fabric, the light-shielding film and the bottom sheet fabric are laminated, a hole-making means is applied to form different penetrating luminous transmittance for the seventh embodiment to the tenth embodiment. In Table 3, the penetrating luminous transmittance for the seventh embodiment to the tenth embodiment are 2.85%, 5.75%, 7.29% and 12.16%, respectively, and the corresponding measured diffuse luminous transmittance are 0.67%, 1.07%, 1.07% and 1.62%, respectively. By applying the foregoing equation, the haze values for the seventh embodiment to the tenth embodiment are 19.0%, 15.63%, 12.77% and 11.76%, respectively. Namely, the composite fabric in each of the seventh embodiment to the tenth embodiment is deemed to be clearly visible.

Referring now to Table 4 and Table 5, the surface sheet fabric and the bottom sheet fabric for each of comparisons 1 to 3 and an eleventh embodiment to a thirteenth embodiment adopt a light-color woven fabric, while the light-shielding film adopts the Cs-W PU film contained Cs-W particles, in which the Cs-W can be, but not limited to, CsₓWO₃.

TABLE 4

| | Light-shielding | Tₚ | T_{d} | Haze value |
|---|---|---|---|---|
| Comparison | film | (%) | (%) | (%) |
| 1 | Cs-W PU film | 4.71 | 11.8 | 71 |
| | without Cs-W | | | |
| | particles | | | |
| 2 | Cs-W PU film | 4.68 | 2.8 | 37 |
| | contained 5 wt % | | | |
| | Cs-W particles | | | |
| 3 | Cs-W PU film | 4.65 | 2.3 | 33 |
| | contained 10 wt % | | | |
| | Cs-W particles | | | |

TABLE 5

| | Light-shielding | Tₚ | T_{d} | Haze value |
|---|---|---|---|---|
| Embodiment | film | (%) | (%) | (%) |
| Eleventh | Cs-W PU film | 4.63 | 1.9 | 29 |
| | contained 20 wt % | | | |
| | Cs-W particles | | | |
| Twelfth | Cs-W PU film | 4.61 | 1.5 | 25 |
| | contained 30 wt % | | | |
| | Cs-W particles | | | |
| Thirteenth | Cs-W PU film | 4.60 | 0.82 | 15 |
| | contained 50 wt % | | | |
| | Cs-W particles | | | |

Referring to Table 4, in each of the comparison 1 to the comparison 3, after the surface sheet fabric, the light-shielding film and the bottom sheet fabric are laminated, a hole-making means is applied to form close but different penetrating luminous transmittance for the comparison 1 to the comparison 3. In Table 4, the light-shielding film of the comparison 1 to the comparison 3 is contained 0 wt %, 5 wt % and 10 wt % Cs-W particles, respectively. Thus, the penetrating luminous transmittance for the comparison 1 to the comparison 3 are 4.71%, 4.68% and 4.65%, respectively, and the corresponding measured diffuse luminous transmittance are 11.8%, 2.8% and 2.3%, respectively. By applying the foregoing equation, the haze values for the comparison 1 to the comparison 3 are 71%, 37% and 33%1, respectively. Namely, the composite fabric in each of the comparison 1 to the comparison 3 is deemed to be away from being clearly visible.

Referring to Table 5, in each of the eleventh embodiment to the thirteenth embodiment, after the surface sheet fabric, the light-shielding film and the bottom sheet fabric are laminated, a hole-making means is applied to form close but different penetrating luminous transmittance for the eleventh embodiment to the thirteenth embodiment. In Table 5, the light-shielding film of the eleventh embodiment to the thirteenth embodiment is contained 20 wt %, 30 wt % and 50 wt % Cs-W particles, respectively. Thus, the penetrating luminous transmittance for the eleventh embodiment to the thirteenth embodiment are 4.63%, 4.61% and 4.60%, respectively, and the corresponding measured diffuse luminous transmittance are 1.9%, 1.5% and 0.82%, respectively. By applying the foregoing equation, the haze values for the eleventh embodiment to the thirteenth embodiment are 29%, 25% and 15%, respectively. Namely, the composite fabric in each of the eleventh embodiment to the thirteenth embodiment is deemed to be clearly visible.

Referring to Table 4 and Table 5, though the penetrating luminous transmittance for the comparison 1 to the comparison 3 are close to those for the eleventh embodiment to the thirteenth embodiment, yet the weight percentage concentrations of the blended Cs-W particles in the comparison 1 to the comparison 3 are lower than those in the eleventh embodiment to the thirteenth embodiment, by which the diffuse luminous transmittance and the haze value would be significantly affected. If the weight percentage concentration of the light-shielding particles in the light-shielding film is not big enough, specifically less than 20 wt %, then the corresponding composite fabric would be away from clear visibility. In this disclosure, the weight percentage concentration of the light-shielding particles in the light-shielding film is ranging from 20˜60 wt %, so that visibility of the corresponding composite fabric would be acceptable.

Referring to Table 6, the surface sheet fabric and the bottom sheet fabric for each of the comparison 4, the comparison 5 and the fourteenth embodiment adopt a light-color woven fabric, while a TiO₂-modified PU film, a transparent PU film, and a PU nanofiber film contained carbon black particles (with 50 wt %) are individually used for the light-shielding film. In Table 6, though the three listed examples do have the same penetrating luminous transmittance (4.5%), yet the corresponding haze values are different due to different light-shielding films. With the same penetrating luminous transmittance, the comparisons 4, 5 demonstrate higher haze values that stand for less clear visibility. On the other hand, even with the same penetrating luminous transmittance, the fourteenth embodiment including the light-shielding film contained light-shielding particles (carbon black particles) demonstrates a lower haze value, implying that the corresponding composite fabric is clearly visible.

TABLE 6

| | Light-shielding | Tₚ | T_{d} | Haze value |
|---|---|---|---|---|
| | film | (%) | (%) | (%) |
| Comparison | TiO₂-modified PU | 4.5 | 9.3 | 67.4 |
| 4 | plastic film | | | |
| Comparison | Transparent PU | 4.5 | 11.8 | 72.4 |
| 5 | plastic film | | | |
| Fourteenth | Carbon black PU | 4.5 | 0.8 | 15.1 |
| embodiment | nonfiber film | | | |

In another aspect of this disclosure, a light-shielding nanofiber film contains light-shielding particles or powders. In one embodiment, the light-shielding film 2 is made of a polyurethane or a thermoplastic polyester elastomer. In one embodiment, the light-shielding particles or powders can be made of a material having a reflectivity less than 5% (with a powder-tablet penetration rate <0.5%) with respect to both the visible light with a wavelength ranging from 380-780 nm and the near infrared light with a wavelength ranging 780-2100 nm, tested and confirmed by a reflective light testing on a VIS-NIR integrating-sphere spectrometer. Thus, the light-shielding nanofiber film can be a carbon black-modified light-shielding film contained carbon black particles or powders, a Cs-W-modified light-shielding film contained Cs-W particles or powders, a carbon nanotube-modified light-shielding film contained carbon nanotube particles or powders, a graphene-modified light-shielding film contained graphene particles or powders, a coke-modified light-shielding film contained coke particles or powders or a ZrC-modified light-shielding film contained ZrC particles or powders.

The light-shielding particles or powders in the light-shielding nanofiber film shares 20˜60 wt % of the entire light-shielding nanofiber film, so that a specific light shielding effect can be furnished to the light-shielding nanofiber film, in which wt % stands for the weight percentage concentration. In one embodiment, the light-shielding nanofiber film has a thickness ranging from 1˜80 μm.

Referring to Table 7, the fifteenth embodiment and the sixteenth embodiment apply carbon black PU nanofiber films contained 60 wt % and 30 wt % carbon black particles or powders, respectively. After testing, different diffuse luminous transmittance, less than 1.0% and 6.0%, are provided, respectively.

TABLE 7

| Embodiment | Light-shielding film | T_{d} (%) |
|---|---|---|
| Fifteenth | Carbon black PU nanofiber film | <1.0 |
| | contained 60 wt % carbon black | |
| Sixteenth | Carbon black PU nanofiber film | <6.0 |
| | contained 30 wt % carbon black | |

Referring to Table 8, the seventeenth embodiment and the eighteenth embodiment apply Cs-W PU nanofiber films contained 50 wt % and 20 wt % Cs-W particles or powders, respectively. After testing, different diffuse luminous transmittance, less than 24.5% and 29.2%, are provided, respectively.

TABLE 8

| Embodiment | Light-shielding film | T_{d} (%) |
|---|---|---|
| Seventeenth | Cs-W PU nanofiber film | <24.5 |
| | contained 50 wt % Cs-W | |
| Eighteenth | Cs-W PU nanofiber film | <29.2 |
| | contained 20 wt % Cs-W | |

From Table 7 and Table 8, the more the weight percentage concentration of the carbon black or Cs-W particles or powders in the nanofiber film is, the better the light-shielding effect can be. In addition, a better light-shielding effect can be obtained by doping the carbon black than the Cs-W. Nevertheless, both the aforesaid kinds of particles or powders can be applied for the composite fabric of this disclosure.

In the composite fabric with holes provided by this disclosure, at least one of the light-shielding film, the surface sheet fabric and the bottom sheet fabric is furnished with holes. In addition, with the light-shielding film to be contained light-shielding particles or powders and to limit the range of the penetrating luminous transmittance, both the light-transmitting and the light-shielding effects can be obtained simultaneously. Thus, by applying the composite fabric with holes in accordance with this disclosure, the scene behind the composite fabric can be clearly observed.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A composite fabric with holes, comprising:
a surface sheet fabric;
a light-shielding film, containing light-shielding particles or powders; and
a bottom sheet fabric;
wherein the surface sheet fabric and the bottom sheet fabric sandwich the light-shielding film;
at least one of the surface sheet fabric, the bottom sheet fabric and the light-shielding film is furnished with a plurality of holes;
a total luminous transmittance of the composite fabric is smaller than 30%.

2. The composite fabric with holes of claim 1, wherein the light-shielding film is a polymer film or a nanofiber film.

3. The composite fabric with holes of claim 2, wherein the light-shielding film is made of a polyurethane or a thermoplastic elastomer.

4. The composite fabric with holes of claim 1, wherein the light-shielding particles or powders share 20˜60 wt % of the light-shielding film.

5. The composite fabric with holes of claim 1, wherein the light-shielding film is one of a carbon black-modified light-shielding film contained carbon black particles or powders, a Cs-W-modified light-shielding film contained Cs-W particles or powders, a carbon nanotube-modified light-shielding film contained carbon nanotube particles or powders, a graphene-modified light-shielding film contained graphene particles or powders, a coke-modified light-shielding film contained coke particles or powders, and a ZrC-modified light-shielding film contained ZrC particles or powders.

6. The composite fabric with holes of claim 1, wherein the surface sheet fabric and the bottom sheet fabric is a woven or non-woven fabric.

7. The composite fabric with holes of claim 1, wherein the light-shielding film are laminated to the surface sheet fabric and the bottom sheet fabric by an adhesive.

8. The composite fabric with holes of claim 1, wherein the light-shielding film are laminated to the surface sheet fabric and the bottom sheet fabric by hot pressing.

9. The composite fabric with holes of claim 1, wherein the plurality of holes has a total area occupying at least 0.25% of an area of the composite fabric.

10. The composite fabric with holes of claim 1, wherein the composite fabric has a haze value less than 33%.

11. The composite fabric with holes of claim 1, wherein the light-shielding film has a thickness between 1 μm and 80 μm.

12. A light-shielding nanofiber film, made of a polyurethane or a thermoplastic elastomer, comprising light-shielding particles or powders, wherein the light-shielding particles or powders share 20˜60 wt % of the light-shielding nanofiber film.

13. The light-shielding nanofiber film of claim 12, wherein the light-shielding nanofiber film has a total luminous transmittance less than 30%.

14. The light-shielding nanofiber film of claim 12, wherein the light-shield nanofiber film is one of a carbon black-modified light-shielding film contained carbon black particles or powders, a Cs-W-modified light-shielding film contained Cs-W particles or powders, a carbon nanotube-modified light-shielding film contained carbon nanotube particles or powders, a graphene-modified light-shielding film contained graphene particles or powders, a coke-modified light-shielding film contained coke particles or powders, and a ZrC-modified light-shielding film contained ZrC particles or powders.

15. The light-shielding nanofiber film of claim 14, wherein the light-shielding nanofiber film has a thickness between 1 μm and 80 μm.
